(19) United States
(12) Patent Application Publication
(10) Pub. No.: US 2016/0356316 A1
(43) Pub. Date: Dec. 8, 2016

(54) RETENTION ASSEMBLY FOR CYCLICAL LOADING

(71) Applicant: Caterpillar Inc., Peoria, IL (US)

(72) Inventors: Scott R. Schuricht, Princeville, IL (US); Bin Li, Dunlap, IL (US)

(73) Assignee: Caterpillar Inc., Peoria, IL (US)

(21) Appl. No.: 15/244,406

(22) Filed: Aug. 23, 2016

(51) Int. Cl. F16C 35/067; F16C 19/16

(52) U.S. Cl. CPC F16C 35/067; F16C 19/16; F16C 2226/14; F16C 2360/22

(57) ABSTRACT

A retention assembly for handling cyclical axial loads is disclosed. The retention assembly comprises a bearing, a motor, and a bushing element. The bearing is mounted around an axis of a shaft The motor is adapted to operate the shaft through a coupler. The bushing element is mounted around the axis of the shaft. The bushing element has a hollow cylindrical configuration defining an internal volume for accommodating the coupler and a portion of the shaft therein. An internal diameter of the bushing element is larger than an external diameter of each of the coupler and the shaft respectively. One end of the bushing element is in a contacting relationship with the bearing. The bushing element is adapted to hold the bearing in place through an interference fit with a motor housing ID for withstanding the cyclical axial loads.

### TECHNICAL FIELD

The present disclosure relates to a retention assembly system employed in an engine and more specifically to the retention assembly for handling cyclical axial loads.

### BACKGROUND

Engine systems utilize a heat exchanger, i.e. a coolant system that regulates flow of a coolant through or around conduits to prevent the machine from overheating. The coolant system may include an electronic thermostat unit to maintain the temperature of the engine within permissible limits.

Conventionally, retaining rings or snap rings are utilized to hold components of the coolant system over a shaft. The exposed portion of the retaining rings act as a holding surface for retaining the components of the cooling system at a desired location.

However, during operation, the retaining rings may experience high axial cyclical load proximate to the shaft. This may lead to early fatigue failure of the retaining rings and/or cause breakage of the retaining rings. Further, in some situations, the compromised retaining rings may also lead to leakage of the coolant from the cooling system, affecting the cooling of the engine and associated components. As a result, the machines may have high downtime and additional repair cost.

U.S. Pat. No. 4,000,559 describes a tandem arrangement of an axially loaded rolling bearing with a hydrostatic thrust bearing. The hydrostatic thrust bearing undertakes an axial force from a piston action and hydrostatic fluid is conducted from a piston chamber using a controlled flow-off channel system.

### SUMMARY OF THE DISCLOSURE

A retention assembly for handling cyclical axial loads is disclosed. The retention assembly comprises a hearing, a motor, and a bushing element, The bearing is mounted around an axis of a shaft. The motor is adapted to operate the shaft through a coupler. The bushing element is mounted around the axis of the shaft. The bushing element has a hollow cylindrical configuration defining an internal volume for accommodating the coupler and a portion of the shaft therein. An internal diameter of the bushing element is larger than an external diameter of each of the coupler and the shaft respectively. One end of the bushing element is in a contacting relationship with the bearing. The bushing element is adapted to hold the bearing in place through an interference fit with a motor housing inner diameter (ID) for withstanding the cyclical axial loads.

Other features and aspects of this disclosure will be apparent from the following description and the accompanying drawings.

### BRIEF DESCRIPTION OF THE DRAWINGS

FIG. 1 is a perspective view of an exemplary electronic thermostat of an engine, in accordance with the concepts of the present disclosure;

FIG. 2 is a side sectional view of the electronic thermostat taken along a plane 1-1′ of FIG. 1, in accordance with the concepts of the present disclosure;

FIG. 3 is a side sectional view of a portion of a retention system having a bushing element, in accordance with the concepts of the present disclosure; and

FIG. 4 is a perspective view of the bushing element, in accordance with the concepts of the present disclosure.

### DETAILED DESCRIPTION

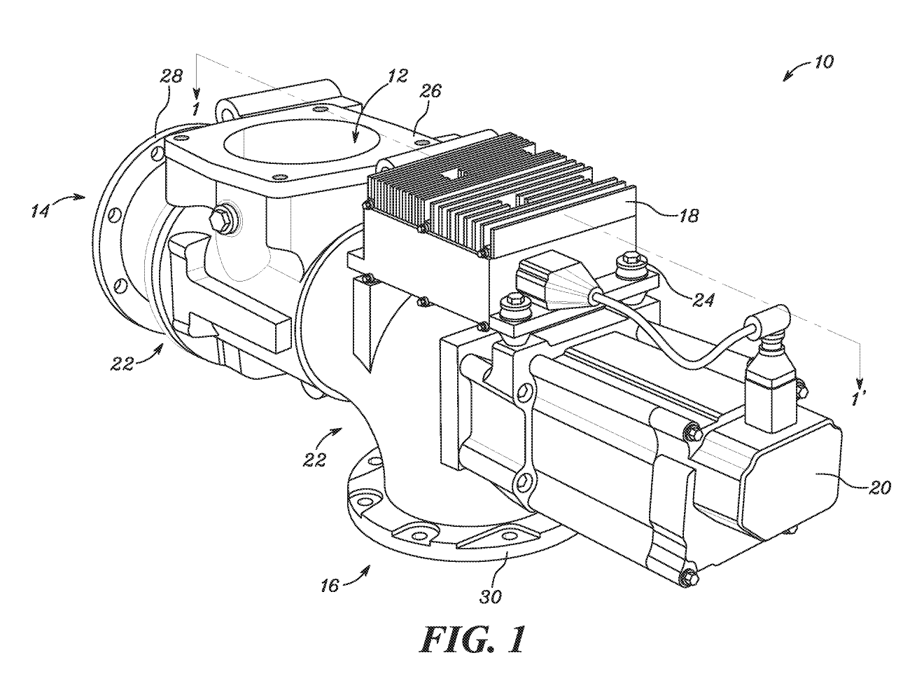

Referring to FIG. 1, an electronic thermostat 10 of an engine (not shown) is illustrated. The electronic thermostat 10 includes an inlet 12, a first outlet 14 and a second outlet 16. The inlet 12, the first outlet 14 and the second outlet 16 are in fluidic communication with each other. Further, the first outlet 14 is connected to a radiator (not shown) and the second outlet 16 is connected to an engine coolant pump (not shown). The electronic thermostat 10 includes an electronic controller 18 that utilizes a motor 20 for controlling a flow of an engine coolant inside conduits 22. The motor 20 is coupled within the electronic thermostat 10 via a number of fasteners 24. The electronic thermostat 10 is employed in the engine to control the flow of the engine coolant to a heat exchanger (not shown) or the radiator. The electronic controller 18 closes the flow of the engine coolant to the radiator after the engine is started, when the engine coolant is at a relatively low or cold temperature. When a predetermined higher or hot temperature is reached, the electronic controller 18 alters the flow of the engine coolant, and thereby allows the engine coolant to flow towards the radiator to maintain optimum temperature in the system.

The inlet 12, the first outlet 14, and the second outlet 16 include a first flange 26, a second flange 28, and a third flange 30 respectively for fastening on the engine. The electronic thermostat 10 is mounted on the engine via a number of fasteners (not shown). Although the engine is described as the internal combustion engine herein, alternatively, the engine may include any other internal combustion engine, such as, a spark ignition engine, a compression ignition engine, a natural gas engine, among others to carry out principles of current disclosure without departing from the meaning and scope of the disclosure. Further, the electronic controller 18 may include electronics such as a logic board, a number of sensors or a number of relays among others to carry out principles of current disclosure without departing from the meaning and scope of the disclosure.

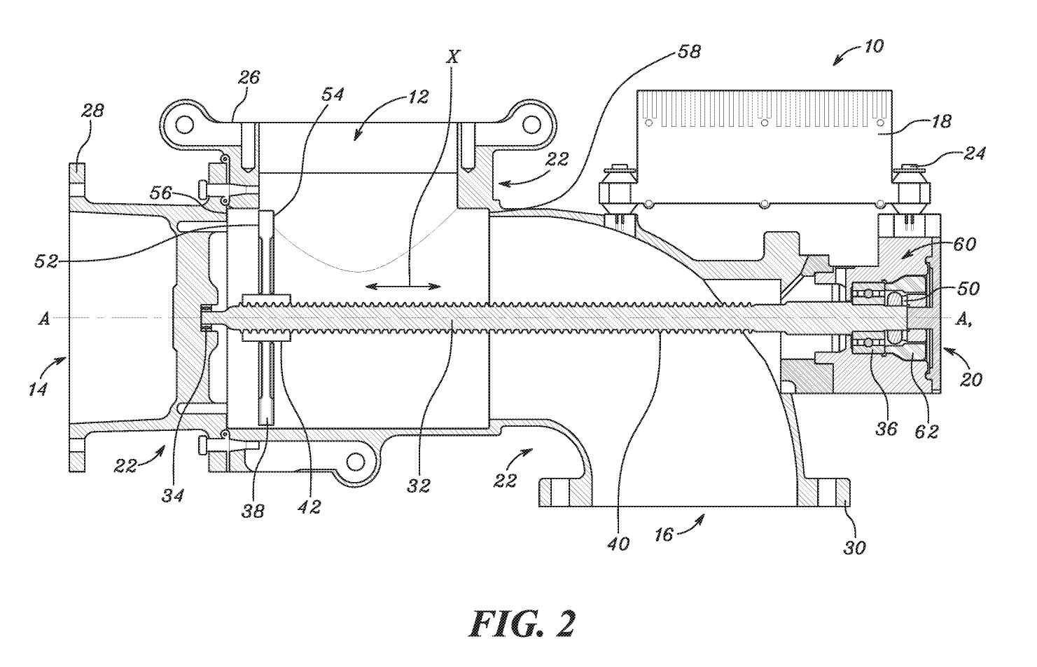

Referring to FIG. 2, a shaft 32 of the electronic thermostat 10 is supported between a first bearing 34 and a second bearing 36. The shaft 32 is driven by the motor 20. A disc 38 is mounted on the shaft 32 having threads 40 using a hub 42. The hub 42 is internally splined (not shown). When the shaft 32 is rotated clockwise or anticlockwise, the threads 40 facilitate the disc 38 to move in a rightward or a leftward direction along a direction ‘X’.

The movement of the disc 38 along the shaft 32 allows the electronic thermostat 10 to regulate flow of the engine coolant from the inlet 12 to the first outlet 14 or the second outlet 16. The disc 38 is configured to alter the path of the engine coolant by alternatively closing the first outlet 14 and the second outlet 16. The disc 38 may be moved in such a manner that a first surface 52 comes in contact with a third surface 56 for closing the first outlet 14. Similarly, the disc 38 may he moved in such a manner that a second surface 54 comes in contact with a fourth surface 58 for closing the second outlet 16. The shaft 32 is coupled to the motor 20 via a coupler assembly 44 (also known as coupling assembly 44). The coupler assembly 44 having a first coupling member 46 (also called a first coupler) and a second coupling member 48 (also called a second coupler). The first coupling member 46 and the second coupling member 48 are attached via a number of fasteners 50.

The first bearing 34 and the second bearing 36 support the shaft 32 for axial as well as the radial forces occurring due to operations of the shaft 32 during flow of the engine coolant. During operations, the electronic thermostat 10 may facilitate multiple rotation of the shaft 32 using the motor 20. As a result, the first bearing 34 and the second bearing 36 bear repetitive cyclical axial loads. Further, the electronic thermostat 10 may include various other components, such as actuators, gears, hoses, etc. which are not labeled in FIG. 1 and 2 for the purpose of simplicity.

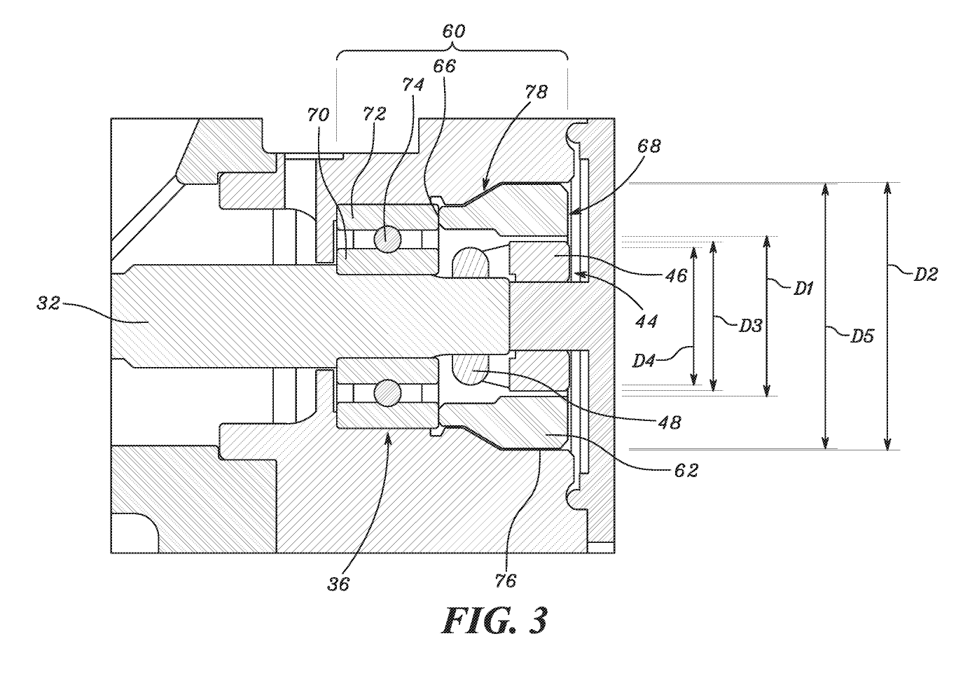

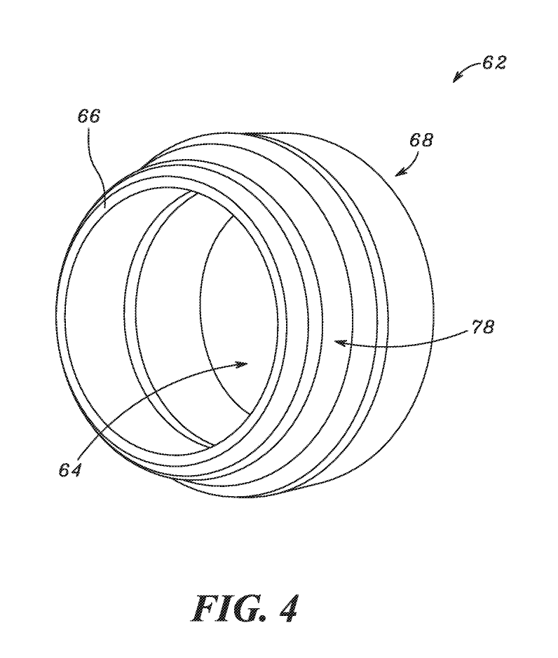

Referring to FIGS. 3 and 4, the second bearing 36 is secured via a retention assembly 60 for handling the cyclical axial loads. The retention assembly 60 includes a bushing element 62 mounted around an axis A-A′ of the shaft 32. The bushing element 62 has a hollow cylindrical configuration defining an internal volume 64 for accommodating the coupler assembly 44 and a portion of the shaft 32. The bushing element 62 has an internal diameter D1 and an external diameter D2. The internal diameter D1 is configured to define the internal volume 64. The bushing element 62 further includes a first surface 66 (i.e. first end 66) and a second surface 68 (i.e. second end 68). The bushing element 62 is manufactured from materials, such as steel, or any other suitable material. The second bearing 36 (also called bearing 36) includes an inner race 70, an outer race 72 along with a number of bearing balls 74 disposed in between.

The bushing element 62 is adapted to hold the bearing 36 in place through an interference fit with a motor housing inner diameter (ID) (see D5) for withstanding the cyclical axial loads. The bushing element 62 may also he fitted in the internal groove 76 using other means, for example mechanical fasteners, such as bolts, rivets according to the application. Also, the bushing element 62 may have a graduating portion 78 which may vary based on the application. The graduating. portion 78 is a tapered portion of the bushing element 62. The bearing 36 and the first end 66 of the bushing element 62 maintain a contacting relationship.

Further, the bushing element 62 may also be secured via fasteners, adhesives or any other suitable fasteners. Also, the bushing element 62 is of cylindrical shape such that the internal diameter D1 of the bushing element 62 is larger than an external diameter D3 of the first coupling member 46 and an external diameter D4 of the second coupling member 48 respectively. Further, the hushing element 62 may have an alternate configuration, shapes, graduating portions other than cylindrical which may vary in length based on the application.

### INDUSTRIAL APPLICABILITY

The bushing element 62 may be easily fabricated and hence offers a cost effective and robust solution. The bushing element 62 may be easily retrofitted in the existing systems. The retention assembly 60 will also help elongate bearing replacement frequency and may prevent damage to the electronic thermostat 10, further preventing leakage or loss of engine coolant.

The bushing element 62 may be easily fitted or fixed by altering the shape for the desired fitment or application into existing shaft support bearings for a prolonged service life. Also, the bushing element 62 may be easily installed with use of conventional tools, such as press machine without requiring any specialized machinery.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed, Such embodiments should be understood to fall within the scope of the present disclosure as determined based upon the claims and any equivalents thereof.

What is claimed is:

1. A retention assembly for handling cyclical axial loads, the retention assembly comprising:
a bearing mounted around an axis of a shaft;
a motor adapted to operate the shaft through a coupler; and
a bushing element mounted around the axis of the shaft, the bushing element having a hollow cylindrical configuration defining an internal volume for accommodating the coupler and a portion of the shaft therein, wherein an internal diameter of the bushing element is larger than an external diameter of each of the coupler and the shaft respectively, wherein one end of the bushing element is in a contacting relationship with the bearing,
wherein the bushing element to adapted to hold the bearing in place through an interference fit with a motor housing inner diameter (ID) for withstanding the cyclical axial loads.
